(19) United States
(12) Patent Application Publication
(10) Pub. No.: US 2022/0276059 A1
(43) Pub. Date: Sep. 1, 2022

(54) NAVIGATION SYSTEM AND NAVIGATION METHOD

(71) Applicant: CANON KABUSHIKI KAISHA, Tokyo (JP)

(72) Inventor: Takuya Hara, Kanagawa (JP)

(21) Appl. No.: 17/678,355

(22) Filed: Feb. 23, 2022

(30) Foreign Application Priority Data
Mar. 1, 2021 (JP) 2021-031599

(51) Int. Cl. G01C 21/30; G06T 7/73; G06V 10/74; G06V 20/56; G06V 10/80

(52) U.S. Cl. CPC G01C 21/30; G06T 7/73; G06V 10/74; G06V 20/588; G06V 10/806; G06T 2207/30252

(57) ABSTRACT

A navigation system includes an imaging device to image a region including a traveling road, a map information acquisition unit to acquire map information, a position information acquisition unit to acquire position information on the mobile body, a traveling road conversion unit to convert images of the region into traveling road data, a traveling road combining unit to use a feature point of the traveling road to generate combined data in which traveling road data corresponding to the images are combined, a matching processing unit to match between the combined data and a traveling road to estimate a current position of the mobile body, a navigation information generation unit to generate navigation information, an image combining unit to generate an image in which the image of the region and the navigation information are combined, and a display unit to display the combined image.

### BACKGROUND OF THE INVENTION

### Field of the Invention

The present disclosure relates to a navigation system and a navigation method for a vehicle.

### Description of the Related Art

In navigation systems for vehicles, it is known that, in detection of the current position of a vehicle, detection accuracy is improved by a map matching process of comparing a traveling road of the vehicle and map information. It is also known that the accuracy of a map matching process improves more as a traveling road to be matched is longer.

On the other hand, as a travel distance of the vehicle becomes longer, output errors of a sensor that is used to acquire vehicle information are accumulated, and hence the actual traveling road of the vehicle may not match a traveling road estimated on the basis of the output of a sensor in some cases.

Japanese Patent Application Publication No. 2009-250718 discloses a method for recognizing a structure along a road and correcting a vehicle position in order to improve the accuracy of a map matching process.

However, even when the method disclosed in Japanese Patent Application Publication No. 2009-250718 is used, although the position of a host vehicle can be corrected in accordance with the position of a structure, the current position of the host vehicle on a map cannot be specified from the structure, and the matching accuracy may be improved significantly in some cases.

### SUMMARY OF THE INVENTION

Therefore, in view of the above-mentioned problems, the present disclosure has an object to estimate the current position of a mobile body with high accuracy to provide navigation information.

According to an aspect of the present disclosure, it is provided a navigation system, including an imaging device disposed in a mobile body and configured to image a region including a traveling road of the mobile body, a map information acquisition unit configured to acquire map information, a position information acquisition unit configured to acquire position information on the mobile body, a traveling road conversion unit configured to convert a plurality of images of the region imaged by the imaging device into pieces of traveling road data each indicating a traveling road of the mobile body, a traveling road combining unit configured to use a feature point of the traveling road included in the traveling road data to generate combined data in which the pieces of traveling road data corresponding to the plurality of images are combined, a matching processing unit configured to perform a process of matching between the combined data and a traveling road included in the map information to estimate a current position of the mobile body, a navigation information generation unit configured to generate navigation information for the mobile body on the basis of the current position of the mobile body estimated by the matching processing unit, an image combining unit configured to generate a combined image in which the image of the region imaged by the imaging device and the navigation information generated by the navigation information generation unit are combined, and a display unit configured to display the combined image generated by the image combining unit.

In addition, according to an aspect of the present disclosure, it is provided a navigation method including imaging, by an imaging device disposed in a mobile body, a region including a traveling road of the mobile body, acquiring map information, acquiring position information on the mobile body, converting a plurality of images of the region imaged by the imaging device into pieces of traveling road data indicating a traveling road of the mobile body, using a feature point of the traveling road included in the traveling road data to generate combined data in which the pieces of traveling road data corresponding to the plurality of images are combined, performing a process of matching between the combined data and a traveling road included in the map information to estimate a current position of the mobile body, generating navigation information for the mobile body on the basis of the estimated current position of the mobile body, generating a combined image obtained by combining the image of the region imaged by the imaging device and the generated navigation information, and displaying the generated combined image.

Further features of the present invention will become apparent from the following description of exemplary embodiments with reference to the attached drawings.

### BRIEF DESCRIPTION OF THE DRAWINGS

FIG. 1 is a block diagram of a navigation system according to one embodiment;

FIG. 2 is a system block diagram of an image processing unit according to one embodiment;

FIG. 3 is a flowchart of a process executed by the image processing unit in one embodiment;

FIG. 4 is a diagram schematically illustrating an image imaged by an imaging device according to one embodiment;

FIG. 5 is a diagram schematically illustrating an image output by a traveling road determination unit according to one embodiment;

FIG. 6 is a system block diagram of a traveling road combining unit according to one embodiment;

FIG. 7 is a flowchart of a process executed by the traveling road combining unit in one embodiment;

FIGS. 8A to 8C are diagrams schematically illustrating images output by the traveling road combining unit according to one embodiment;

FIG. 9 is a flowchart of a process executed by a navigation system according to one embodiment; and

FIG. 10 is a diagram schematically illustrating a result of a map matching process in one embodiment.

### DESCRIPTION OF THE EMBODIMENTS

Embodiments of the present disclosure are described below with reference to the drawings. Note that the present disclosure is not limited to the following embodiments, and can be changed as appropriate within the range not departing from the gist thereof. In the figures referred to below, components having the same functions are denoted by the same reference symbols, and descriptions thereof are sometimes omitted or simplified.

### First Embodiment

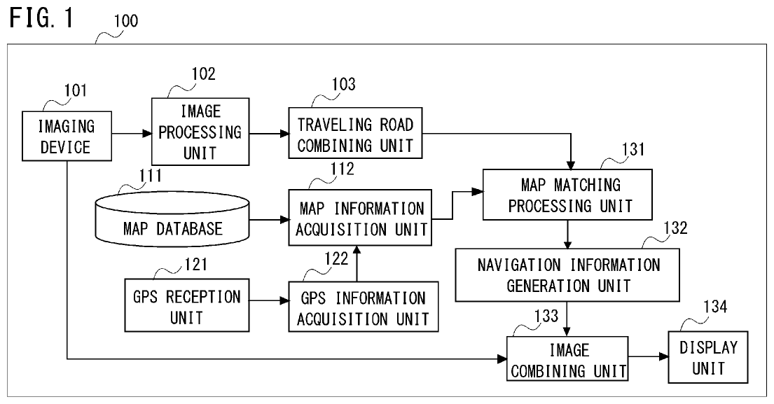

FIG. 1 is a functional block diagram schematically illustrating a navigation system 100 according to the present embodiment. In the present embodiment, the navigation system 100 is mounted to a vehicle as an example of a mobile body. As illustrated in FIG. 1, the navigation system 100 includes an imaging device 101, an image processing unit 102, and a traveling road combining unit 103. The navigation system 100 includes a map database 111, a map information acquisition unit 112, a global positioning system (GPS) reception unit 121, and a GPS information acquisition unit 122. The navigation system 100 further includes a map matching processing unit 131, a navigation information generation unit 132, an image combining unit 133, and a display unit 134.

The imaging device 101 is disposed in a vehicle, and sequentially images a region including a traveling road on which the vehicle travels. The image processing unit 102 performs a process for converting a plurality of images sequentially imaged by the imaging device 101 into traveling road data. The traveling road combining unit 103 generates combined data obtained by combining traveling road data converted by the image processing unit 102 described later.

The GPS reception unit 121 receives signals from a GPS satellite. The GPS information acquisition unit 122 as a position information acquisition unit acquires, from the signals received by the GPS reception unit 121, information on the current position of the vehicle having the navigation system 100 mounted thereon.

The map database 111 stores therein map information used for a matching process performed by the map matching processing unit 131 described later. Note that, in FIG. 1, the map database 111 is included in the navigation system 100, but the map database 111 may be provided outside the navigation system 100. The map information acquisition unit 112 acquires information on the current position of the vehicle from the GPS information acquisition unit 122, and acquires map information around the current position of the vehicle from the map database 111. Note that the acquisition of the information by the map information acquisition unit 112 may be collectively performed for information from the current position to a destination before the start of traveling of the vehicle, or may be sequentially performed during the traveling of the vehicle.

The map matching processing unit 131 estimates the current position of the vehicle by a matching process using the traveling road of the vehicle combined by the traveling road combining unit 103 and the map information around the current position of the vehicle acquired by the map information acquisition unit 112.

The navigation information generation unit 132 generates information on navigation to a destination from the current position of the vehicle estimated by the map matching processing unit 131. The image combining unit 133 combines the information on navigation to the destination generated by the navigation information generation unit 132 and the image imaged by the imaging device 101. Note that the image imaged by the imaging device 101 may be stored in a storage unit (not shown) in the navigation system 100, and the image combining unit 133 may acquire the image from the storage unit. The display unit 134 displays an image combined by the image combining unit 133.

Next, details of a process of the image processing unit 102 in the navigation system 100 are described.

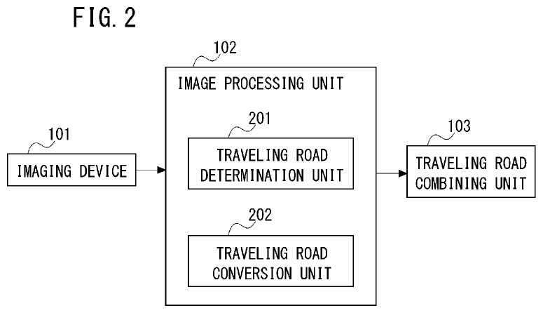

Referring to FIG. 2, the process of the image processing unit 102 is described. As illustrated in FIG. 2, the image processing unit 102 includes a traveling road determination unit 201 and a traveling road conversion unit 202. The traveling road determination unit 201 inputs an image output by the imaging device 101, and performs a traveling road determination process on the basis of the image. The traveling road determination unit 201 outputs a result of the traveling road determination process to the traveling road conversion unit 202.

The traveling road conversion unit 202 processes as an input a process result of the traveling road determination process of the traveling road determination unit 201, and performs a traveling road conversion process on the basis of the process result. The traveling road conversion unit 202 outputs a result of the traveling road conversion process to the traveling road combining unit 103.

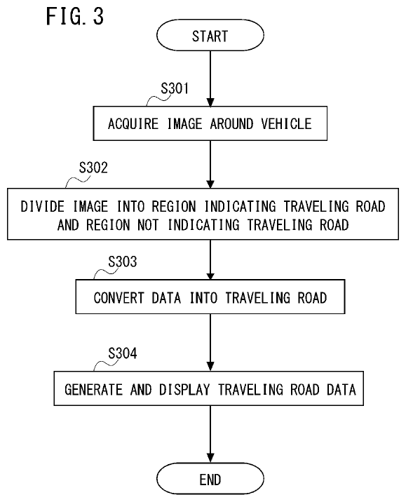

Next, each of the above-mentioned processes executed by the image processing unit 102 is described with reference to a flowchart in FIG. 3. Note that processes executed by the navigation system 100 described below are implemented when a CPU in the navigation system 100 as a computer deploys various kinds of programs onto a memory and executes the programs.

In Step S301, the imaging device 101 images a region including a traveling road on which a vehicle is traveling, and the image processing unit 102 acquires the image imaged by the imaging device 101. The image acquired by the image processing unit 102 is input to the traveling road determination unit 201.

In Step S302, the traveling road determination unit 201 divides the image imaged by the imaging device 101 into a plurality of regions, and determines, for each of the divided regions, whether an image in the region is a traveling road (road). Note that details of the traveling road determination process for the image performed by the traveling road determination unit 201 are described later.

In Step S303, the traveling road conversion unit 202 converts, on the basis of the result of the traveling road determination process by the traveling road determination unit 201 and the map information stored in the map database 111, a part that has been determined as a traveling road by the determination process in Step S302 into a traveling road. The traveling road is a traveling road (road) corresponding to a map type of the map information stored in the map database 111. In Step S304, data of the traveling road converted by the traveling road conversion unit 202 in Step S303 is output to the traveling road combining unit 103. Note that, in the present embodiment, examples of the traveling road data include data of a road pattern converted into a road shape.

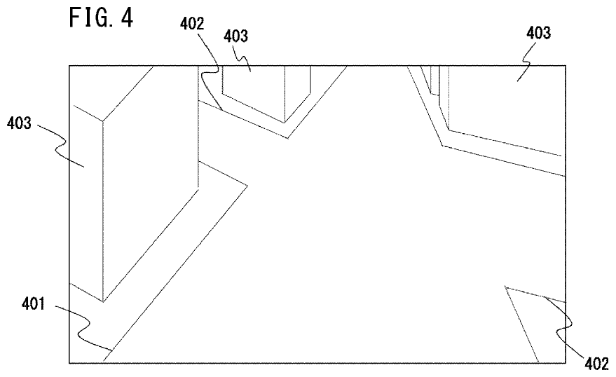

FIG. 4 is an example of an image around the vehicle acquired by the imaging device 101. In the example illustrated in FIG. 4, the imaging device 101 is mounted to the vehicle so as to be able to image a road in a traveling direction of the vehicle. The image illustrated in FIG. 4 includes a road 401 on which the vehicle is traveling, a road 402 intersecting the road 401 in a cross shape, and buildings 403 along the road 401.

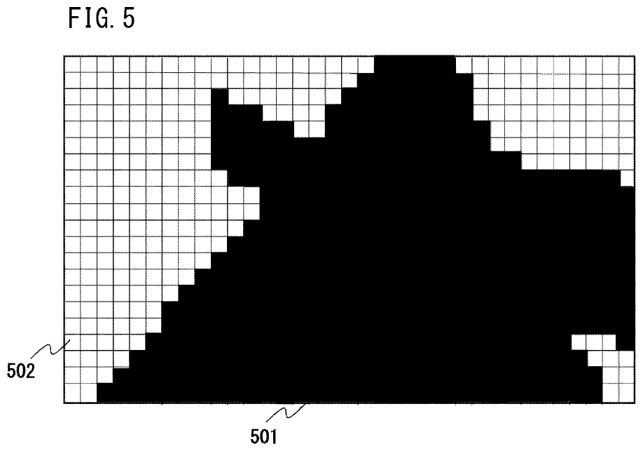

FIG. 5 illustrates an example of a process result when the traveling road determination unit 201 performs a traveling road determination process on the image illustrated in FIG. 4. The traveling road determination unit 201 divides the image into a plurality of regions, and discriminates each of the divided regions into a region 501 (square part filled in black in FIG. 5) determined to be a road as a traveling road and a region 502 (square part filled in white in FIG. 5) determined not to be a road. Note that, in the example illustrated in FIG. 5, as an example, the image is divided into a plurality of regions by squares with predetermined sizes, and the divided regions are discriminated into the region 501 and the region 502. However, in the traveling road determination process for the image by the traveling road determination unit 201, the entire image is not necessarily required to be evenly divided by the same squares. For example, a region at the lower part of the image closer to the position of the vehicle may be divided by smaller squares, and a region at the upper part of the image farther from the position of the vehicle may be divided by larger squares. In this manner, the size of the region to divide the image can be changed depending on a distance from the position of the vehicle, so that the accuracy of traveling road determination for a region at a position closer to the vehicle can be improved.

In the present embodiment, the traveling road determination unit 201 uses a learning model to perform a traveling road determination process. More specifically, ground truth data in which images acquired by the imaging device 101 are divided into regions of traveling roads and regions other than traveling roads and the regions are labelled is prepared in advance, and a learning model is created by supervised learning. Note that a learning algorithm used to learn a learning model can be implemented by a publicly known machine learning engine. For example, a support vector machine (SVM) can be employed as a learning algorithm.

Next, an example of a learning model used to implement the traveling road conversion unit 202 is described. The traveling road conversion unit 202 inputs an image in which a region of a traveling road and a region other than a traveling road determined by the traveling road determination unit 201 are labelled, and outputs data obtained by converting the image acquired by the imaging device 101 into a traveling road. As a learning model, supervised learning with which an image indicating a correct road shape for the image in which regions of roads as traveling roads and regions other than roads are labelled as in FIG. 5 is ground truth data. By using an image acquired by the imaging device 101 in the navigation system 100 as an input image used to learn a learning model, features of an imaging device such as an angle of field and lens distortion of the imaging device 101 can be learned as well.

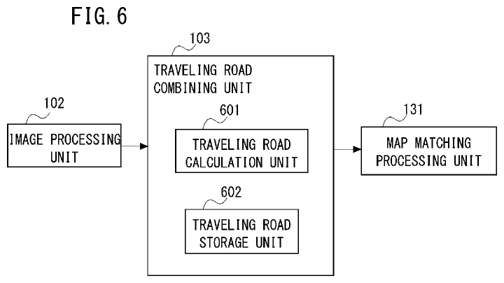

Next, a process executed by the traveling road combining unit 103 is described. As illustrated in FIG. 6, the traveling road combining unit 103 includes a traveling road calculation unit 601 and a traveling road storage unit 602.

The traveling road calculation unit 601 combines traveling roads by using data of a traveling road output by the image processing unit 102 and data of a traveling road stored in the traveling road storage unit 602. Data of traveling roads combined by the traveling road calculation unit 601 is stored in the traveling road storage unit 602. The traveling road calculation unit 601 repeatedly executes the combining using data of a traveling road from the image processing unit 102 and data of the traveling road stored in the traveling road storage unit 602. When the results of the combining of traveling road data are accumulated in the traveling road storage unit 602, traveling road data including a traveling locus of the vehicle can be obtained. The combined traveling road data stored in the traveling road storage unit 602 is output to the map matching processing unit 131.

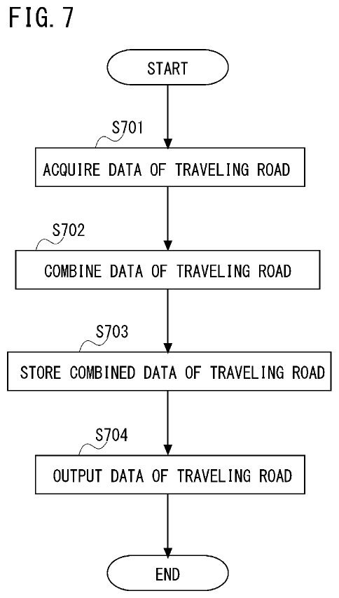

Next, a process executed by the traveling road combining unit 103 is described with reference to a flowchart illustrated in FIG. 7.

In Step S701, the traveling road calculation unit 601 in the traveling road combining unit 103 acquires data of a traveling road as a result of a traveling road conversion process performed by the image processing unit 102.

In Step S702, the traveling road calculation unit 601 acquires data of a traveling road stored in the traveling road storage unit 602. The traveling road calculation unit 601 uses the data of the traveling road acquired from the image processing unit 102 in Step S701 and the data of the traveling road stored in the traveling road storage unit 602 to combine the traveling roads. Note that the combining process is executed each time the image processing unit 102 outputs data of a traveling road to the traveling road combining unit 103.

In Step S703, data of the traveling roads combined by the traveling road calculation unit 601 is stored in the traveling road storage unit 602. In Step S704, the traveling road combining unit 103 outputs the traveling road data stored in the traveling road storage unit 602 in Step S703 to the map matching processing unit 131.

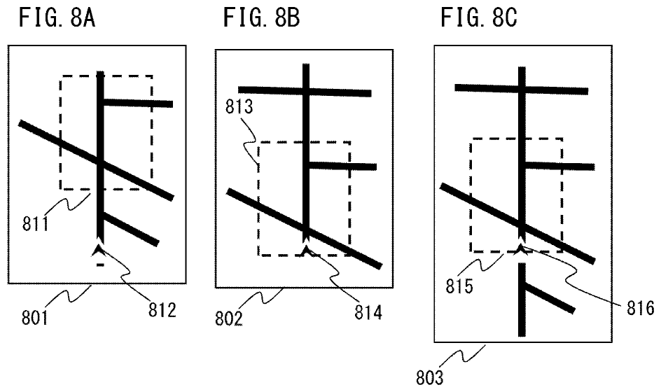

FIG. 8A to FIG. 8C are diagrams illustrating an example of a process for combining traveling roads (roads) by the traveling road combining unit 103. In the example illustrated in FIG. 8A to FIG. 8C, time elapses in the order of FIG. 8A (time A) and FIG. 8B (time B). FIG. 8A illustrates a result (road pattern) of traveling road conversion processing in Step S701 at time A, and FIG. 8B illustrates a result (road pattern) of a traveling road conversion process in Step S701 at time B. FIG. 8C illustrates a result (road pattern) in which the traveling roads at time A and time B are combined.

At time A, the traveling road combining unit 103 acquires road data 801 as traveling road data from the image processing unit 102. The road data 801 includes a region 811 of feature points of a road and an index 812 indicating the position of the vehicle at time A. The traveling road calculation unit 601 stores the road data 801 in the traveling road storage unit 602. Next, at time B after the lapse of time from time A, the traveling road combining unit 103 acquires road data 802 from the image processing unit 102. The road data 802 includes a region 813 of feature points of a road and an index 814 indicating the position of the vehicle at time B.

The traveling road combining unit 103 acquires the road data 801 stored in the traveling road storage unit 602, and generates road data 803 obtained by combining the road data 801 and the road data 802. The traveling road combining unit 103 uses the feature points of the roads included in the road data 801 and 802 to combine the road data 801 and 802. For example, the traveling road calculation unit 601 generates the road data 803 by combining the road data 801 and 802 such that the region 811 of feature points of the road data 801 at time A stored in the traveling road storage unit 602 overlap the region 813 of feature points of the road data 802 at time B. As illustrated in FIG. 8C, the road data 803 includes a region 815 of feature points of roads combined such that the regions 811 and 813 of the feature points of the roads match and an index 816 indicating the position of the vehicle at time B.

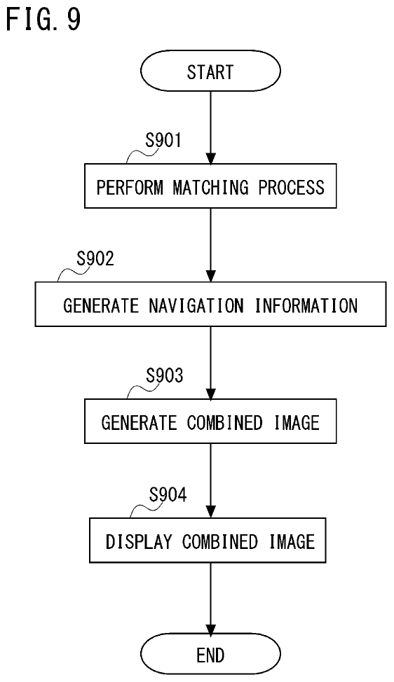

Next, a process executed by the map matching processing unit 131, the navigation information generation unit 132, the image combining unit 133, and the display unit 134 is described with reference to a flowchart in FIG. 9.

In Step S901, the map matching processing unit 131 performs a matching process between a traveling road included in combined data generated by the traveling road combining unit 103 and a traveling road included in map information acquired by the map information acquisition unit 112 from the map database 111. The map matching processing unit 131 estimates the current position of the vehicle by the matching process.

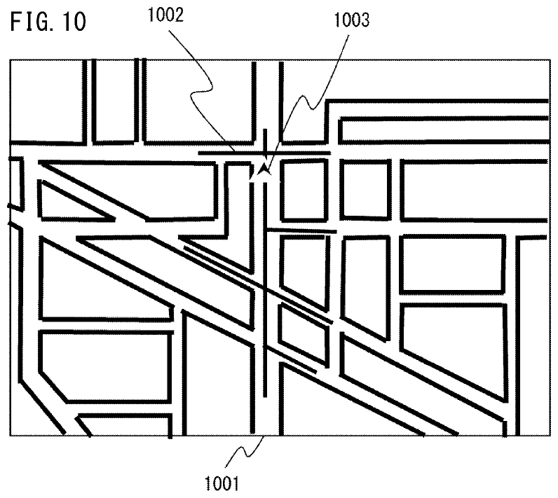

FIG. 10 is a diagram illustrating an example of data of the vehicle position generated by the map matching processing unit 131 by using the road data 803 illustrated in FIG. 8C.

In the data of the vehicle position illustrated in FIG. 10, a map 1001 around the vehicle is generated by using data acquired by the map information acquisition unit 112 from the map database 111 as a map information storage unit. A road 1002 and an index 1003 indicating the vehicle position are a traveling road and an index indicated by traveling road data combined when the traveling road combining unit 103 executes the process in Step S702.

In the present embodiment, the map matching processing unit 131 performs a pattern matching process on data of the map 1001 and data of the road 1002 to estimate the current position of the vehicle. The pattern matching process is a process for specifying feature positions at which particular patterns match each other.

In the pattern matching process in the present embodiment, matching of geometric configurations is performed to specify a location at which a road in the map 1001 and the road 1002 indicated by the traveling road data match, to thereby specify the current position of the vehicle. In the pattern matching process, it is sufficient that the matching of a pattern of a road in the map 1001 and a pattern of the road 1002 succeeds once, and in the second and subsequent matching, the current position of the vehicle can be estimated by overlapping of start point coordinates of the map 1001 and the road 1002. Through the above-mentioned pattern matching process, the current position of the vehicle on the map can be accurately specified. Each time the imaging device 101 acquires an image, the acquired image is used such that the above-mentioned pattern matching process is sequentially performed, and hence the current position of the vehicle on the map can be accurately specified in real time.

Referring back to FIG. 9, in Step S902, the navigation information generation unit 132 generates navigation information to a destination of the vehicle on the basis of the current position of the vehicle estimated in Step S901. Next, in Step S903, the image combining unit 133 generates a combined image obtained by combining the image around the vehicle imaged by the imaging device 101 and the navigation information generated in Step S902. In Step S904, the display unit 134 displays the combined image generated in Step S903. In this manner, information obtained by accurately estimating the current position of the vehicle and navigation information for a destination of the vehicle can be provided to a user riding on the vehicle.

The following two points are to notice in the pattern matching process in the present embodiment.

First, the first point is to specify a traveling road of the vehicle from an image around the vehicle acquired by the imaging device 101 mounted on the vehicle. In the related art, various kinds of sensors such as a speed sensor and an orientation sensor are mounted on a vehicle, and the sensors are used to specify a traveling road of the vehicle. However, data output from various kinds of sensors has an error, and hence the specified current position of the vehicle may be indicated on a traveling road different from a traveling road on which the vehicle is actually traveling. Due to the accumulation of output errors of sensors, the estimation accuracy of the current position of the vehicle may decrease as the traveling distance of the vehicle becomes longer.

In the present embodiment, a road pattern around a vehicle is acquired from an image output from the imaging device 101, and the current position of the vehicle is estimated on the basis of pattern matching between a map and the road pattern. Thus, the current position of the vehicle can be estimated without influence of output errors of sensors, and the current position of the vehicle can be accurately estimated even when the traveling distance of the vehicle is long. In this manner, the navigation system 100 in the present embodiment enables the accurate current position of the vehicle to be estimated by map matching between a traveling road of the vehicle and a map that have been accurately combined.

The second point is that a surrounding road pattern other than a road on which a vehicle is traveling is also used for a matching process. In the related art, GPS information or output of an analog sensor is used such that only a road on which a vehicle has traveled is obtained as road information on the vehicle. On the other hand, in the present embodiment, an image imaged by the imaging device 101 includes not only a road on which the vehicle is currently traveling but also a building and a road around the vehicle. By using the image, not only a road on which the vehicle is traveling but also a surrounding road pattern is used as a feature point for specifying a road of the vehicle, so that the current position of the vehicle can be estimated more accurately.

More specifically, a characteristic road such as a crossroad and a curve among roads rendered on an image imaged by the imaging device 101 is obtained as a feature point on the basis of a road on which the vehicle does not travel. In this manner, the number of feature points used for the above-mentioned pattern matching process increases, and hence the accuracy of the map matching process can be expected to increase.

In navigation systems in the related art, a speed sensor or an orientation sensor is used to acquire information on the latest traveling road of a vehicle, and the current position of the vehicle is estimated by map matching. On the other hand, in the navigation system 100 in the present embodiment, a traveling road around the vehicle is specified on the basis of an image imaged by the imaging device 101, and hence information on a traveling road can be accurately obtained even when the vehicle travels for a long distance. Thus, the above-mentioned map matching process enables the current position of the vehicle to be estimated with higher accuracy than the related art.

While the above is description on the navigation system according to the embodiments of the present disclosure, the navigation system in the present disclosure is not limited to the above-mentioned embodiments and can be variously changed within the scope of the technical concept of the present disclosure.

For example, a plurality of the imaging devices 101 may be provided in the navigation system 100 for the purpose of acquiring traveling road data more accurately. In this case, the imaging devices 101 can be disposed in the vehicle so as to acquire not only an image of a traveling road ahead (traveling direction) of the vehicle but also an image of a traveling road behind (direction opposite to traveling direction) of the vehicle. In this manner, a pattern matching process is performed on the basis of not only the image of the traveling road ahead of the vehicle but also the image of the traveling road behind the vehicle, and hence traveling road patterns around the vehicle can be specified more broadly. As a result, the navigation system 100 can execute a pattern matching process at higher speed because of the increased amount of information on traveling roads of the vehicle.

In the above-mentioned embodiments, the navigation system 100 is not limited to a vehicle, and is applicable to various kinds of mobile bodies. For example, by mounting the above-mentioned navigation system 100 to a disaster relief robot, the robot can be programed so as to travel in a region determined as a road by the above-mentioned process. In this manner, the possibility that the robot moves to a region in which the robot cannot travel can be expected to decrease.

In addition to the above-mentioned learning model, a learning model obtained by learning using ground truth data in which a travelable traveling road and an untravellable traveling road are labelled on the basis of the size and weight of a mobile body may be used. In this manner, for example, when a mobile body moves to a destination in case of emergency, an optimal travel route to arrive at a destination can be specified depending on specifications of the mobile body.

According to the present disclosure, the current position of a mobile body can be more accurately estimated to provide appropriate navigation information to a user of the mobile body.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-031599, filed on Mar. 1, 2021, which is hereby incorporated by reference herein in its entirety.

What is claimed is:

1. A navigation system, comprising:
an imaging device disposed in a mobile body and configured to image a region including a traveling road of the mobile body;
a map information acquisition unit configured to acquire map information;
a position information acquisition unit configured to acquire position information on the mobile body;
a traveling road conversion unit configured to convert a plurality of images of the region imaged by the imaging device into pieces of traveling road data each indicating a traveling road of the mobile body;
a traveling road combining unit configured to use a feature point of the traveling road included in the traveling road data to generate combined data in which the pieces of traveling road data corresponding to the plurality of images are combined;
a matching processing unit configured to perform a process of matching between the combined data and a traveling road included in the map information to estimate a current position of the mobile body;
a navigation information generation unit configured to generate navigation information for the mobile body on the basis of the current position of the mobile body estimated by the matching processing unit;
an image combining unit configured to generate a combined image in which the image of the region imaged by the imaging device and the navigation information generated by the navigation information generation unit are combined; and
a display unit configured to display the combined image generated by the image combining unit.

2. The navigation system according to claim 1, wherein the traveling road conversion unit divides the image imaged by the imaging device into a plurality of regions, and converts the plurality of images into the traveling road data based on determination as to whether each of the divided regions is a traveling road of the mobile body.

3. The navigation system according to claim 1, wherein the traveling road conversion unit converts the image imaged by the imaging device into traveling road data by using a learning model obtained by machine learning in which an image, in which a region of a traveling road of the mobile body and a region other than a traveling road are labelled, is used as truth data.

4. The navigation system according to claim 1, wherein
the imaging device is provided in plurality and disposed in the mobile body, and
one of the plurality of imaging devices images a region including a traveling road ahead of the mobile body, and another of the plurality of imaging devices images a region including a traveling road behind the mobile body.

5. A navigation method, comprising:
imaging, by an imaging device disposed in a mobile body, a region including a traveling road of the mobile body;
acquiring map information;
acquiring position information on the mobile body;
converting a plurality of images of the region imaged by the imaging device into pieces of traveling road data indicating a traveling road of the mobile body;
using a feature point of the traveling road included in the traveling road data to generate combined data in which the pieces of traveling road data corresponding to the plurality of images are combined;
performing a process of matching between the combined data and a traveling road included in the map information to estimate a current position of the mobile body;
generating navigation information for the mobile body on the basis of the estimated current position of the mobile body;
generating a combined image obtained by combining the image of the region imaged by the imaging device and the generated navigation information; and
displaying the generated combined image.

6. A non-transitory storage medium that stores a program causing a computer to execute a navigation method, the navigation method comprising:
imaging, by an imaging device disposed in a mobile body, a region including a traveling road of the mobile body;
acquiring map information;
acquiring position information on the mobile body;
converting a plurality of images of the region imaged by the imaging device into pieces of traveling road data indicating a traveling road of the mobile body;
using feature points of the traveling road included in the traveling road data to generate combined data in which the pieces of traveling road data corresponding to the plurality of images are combined;
performing a process of matching between the combined data and a traveling road included in the map information to estimate a current position of the mobile body;
generating navigation information for the mobile body on the basis of the estimated current position of the mobile body;
generating a combined image obtained by combining the image of the region imaged by the imaging device and the generated navigation information; and
displaying the generated combined image.
